(19) United States
(12) Patent Application Publication
(10) Pub. No.: US 2021/0008871 A1
(43) Pub. Date: Jan. 14, 2021

(54) SPRAY PIPE AND PRINTING PRESS ROLLER CLEANING DEVICE HAVING A SPRAY PIPE

(71) Applicant: Baldwin Technology GmbH, Friedberg (DE)

(72) Inventors: Thorsten Schmutz, Bobingen (DE); Arnold Gold, Friedberg (DE); Ernst Engelhardt, Augsburg (DE)

(21) Appl. No.: 16/970,761

(22) PCT Filed: Feb. 26, 2019
(86) PCT No.: PCT/EP2019/054679

§ 371 Date: Aug. 27, 2020

(30) Foreign Application Priority Data
Feb. 28, 2018 (DE) 10 2018 104 534.4

(51) Int. Cl. B41F 35/00; B41F 35/02; B41F 35/04; B41F 35/06; B05B 1/20

(52) U.S. Cl. CPC B41F 35/002; B41F 35/006; B41F 35/02; B41F 35/04; B41P 2235/26; B05B 1/20; B41P 2235/23; B41P 2235/246; B41F 35/06

(57) ABSTRACT

The invention relates to a spray pipe (1), in particular for a printing press roller cleaning device, wherein the spray pipe (1) extends at least in regions in a longitudinal direction and has a plurality of liquid discharge openings (5, 7, 11) which are formed in a wall of the spray pipe (1), wherein a first liquid discharge opening (5) extends with respect to a first direction and a second liquid discharge opening (7) adjacent to the first liquid discharge opening (5) extends in relation to a second direction, the second direction being different from the first direction in such a way that the direction vectors (6, 8) of the first and the second direction intersect in an atomizing region (10) which is spaced apart from the lateral surface (9) of the spray pipe (1).

The present invention relates in general to fluid spraying devices comprising a channel-shaped fluid chamber having at least one fluid inlet, wherein a plurality of spray openings are formed in a spraying region of the fluid chamber. In detail, the invention relates to a fluid spraying device designed as a spray pipe, in particular for a printing press roller cleaning device. In this context, the spray pipe serves for example in spraying a cleaning cloth in a wash bar assembly, spraying a cylinder of a printing press and/or spraying a brush roller.

For the guiding, processing and propelling of sheet or web printing substrates in printing presses, there needs to be close contact between the printing substrate and the cylinders of a printing press. This results in, for example when paper is used as the printing substrate, paper dust (fibers, coating materials, fillers, etc.), printing ink and in some cases powder dust accumulating on the cylinders. These deposits adversely affect the proper functioning of the printing press cylinders. For print quality as well as operational reliability, it is therefore imperative to regularly rid the printing press cylinders of contaminants.

This is usually done by means of automated cleaning devices which apply washing fluids or similar liquids to the cylinder surfaces to be cleaned and, if necessary, use brushes or cloths to lift off the contaminants dissolved by the washing fluid from the surface of the cylinder.

Water and solvents are generally used as washing and cleaning solutions, same being applied in cumulative or alternating manner to the cylinder surface or a cleaning cloth or cleaning brush respectively. While water is used to remove water-soluble contaminants such as paper dust, for example, a solvent serves in removing oily contaminants such as, for example, ink residues.

For a time-saving and thorough cleaning, it is crucial for the cleaning/washing fluid which is used to be evenly applied across the entire width of the cylinder to be cleaned or the cleaning cloth respectively. A non-uniform distribution of the cleaning/washing fluid over the width of the cylinder to be cleaned, or cleaning cloth respectively, results in some surface areas of the cylinder subject to cleaning not being effectively cleaned while too much cleaning/washing fluid is applied to another surface area as to cause the fluid to drip, whereby the printing press and/or the printed copies become fouled. Furthermore, a uniform distribution of the cleaning/washing fluid enables being able to keep the total amount of cleaning/washing fluid needed low so as to save on resources and costs and avoid unnecessary environmental pollution.

Known from the prior art to uniformly moisten a cylinder surface to be cleaned, or a cleaning cloth respectively, is the use of a spray pipe of the type mentioned at the outset, which serves as a distributor line and exhibits a plurality of fluid discharge openings normally uniformly distributed over its length. Spray nozzles are employed in these fluid discharge openings in order to achieve a uniform spatial distribution of the cleaning/washing fluid after it exits the respective fluid discharge openings. Such spray nozzles have for example a deflector surface arranged downstream of the nozzle opening for deflecting and fanning the stream of fluid exiting the nozzle openings.

The spray nozzles incorporated into the spray pipes are made for example from a soft elastic material, which allows the spray nozzles to be easily interchanged. Such exchangeable spray nozzles are described for example in printed publication EP 1 759 846 A1.

Although such spray nozzles formed from soft elastic material allow them to be exchanged relatively easily by utilizing the elastic properties of the spray nozzles, since the spray nozzles normally only have to be pressed into the fluid discharge opening of the spray pipe, the soft-elastic design to the spray nozzles also results, however, in their relatively rapid wear and corresponding need to be frequently replaced in order to be able to ensure the most evenly possible distribution of the fluid to be sprayed. This in turn increases the operating costs, whereby also not be discounted is that—even though the flexible design of the spray nozzles makes them easier to press into the fluid discharge openings of the spray pipe—replacing all of the spray nozzles in a spray pipe still involves considerable manual labor.

The spray nozzles incorporated into the spray pipes can, however, also be formed from metal or a similar material, whereby these spray nozzles are designed to be screwed into corresponding drill holes in the spray pipe or to be clipped onto corresponding drill holes in the spray pipe. Such spray nozzles are however relatively expensive and can only be replaced with increased expenditure of time.

On the basis of this problem as set forth, the invention is based on the task of further developing a spray pipe of the type cited at the outset to the effect of the spatial and temporal distribution of the fluid application ensuing as uniformly as possible via the spray pipe without the spray pipe itself needing to be regularly serviced or respectively cleaned.

The invention solves this task with the subject matter of independent claim 1, whereby advantageous further developments of the inventive spray pipe are specified in the dependent claims.

Accordingly, the invention in particular relates to a spray pipe which is suitable for use in a printing press roller cleaning device, for example, whereby at least parts of the spray pipe extend in a longitudinal direction and exhibit a plurality of fluid discharge openings formed in a wall of the spray pipe.

At least one first fluid discharge opening of the plurality of fluid discharge openings is aligned with respect to a first direction and a second fluid discharge opening of the plurality of fluid discharge openings (directly) adjacent to the at least one first fluid discharge opening is aligned with respect to a second direction. The second direction differs from the first direction such that the direction vectors of the first and second direction intersect in an atomizing region distanced from the spray pipe.

In other words, the invention provides for the dispensing of respective spray jets via the fluid discharge openings, whereby, however, no spray nozzles in the traditional sense are used to atomize said spray jets. Instead, the jets of fluid dispensed from the fluid discharge openings of the spray pipe are aligned with respect to one another so as to intersect in an atomizing region and correspondingly atomize there.

The term “atomize” as used herein is generally to be understood as the dissipating of a fluid into fine droplets.

The distance or respectively position of the atomizing region in relation to the spray pipe can be accordingly regulated by a suitable selection of the first and second direction and the distance between the at least one first fluid discharge opening and the second fluid discharge opening directly adjacent thereto.

According to a further development of the inventive spray pipe, it is provided for the spray pipe to have a plurality of first fluid discharge openings with associated second fluid discharge openings. In other words, the spray pipe exhibits a plurality of groups, each consisting of a first and a second fluid discharge opening directly adjacent thereto. It is advantageously provided for the respective direction vectors of the directions, relative to which the first and second fluid discharge openings are aligned, to lie in a common plane.

Particularly in cases in which the inventive spray pipe is for example used in a wash bar, it is advantageous for the direction vectors of the first and second direction to intersect in the atomizing region at an intercept point, the shortest distance of which to the surface area of the spray pipe is at most three times the inner diameter of the spray pipe and at least half the inner diameter of the spray pipe. Of course, other dimensions are in principle also possible.

A particularly effective atomization of the streams of fluid dispensed from the fluid discharge openings can be achieved when there is an angle spanning 10° to 50°, preferably 20° to 40° and more preferentially 25° to 35°, between the first direction vector and a line intersecting the first fluid discharge opening and perpendicular to the surface area of the spray pipe. The same also applies representatively to the second direction vector and the second fluid discharge opening. At this point, however, it should be noted that the angle spanned between the first direction vector and the perpendicular line does not necessarily need to be identical to the angle spanned between the second direction vector and corresponding perpendicular line.

According to embodiments of the inventive spray pipe, the fluid discharge openings each exhibit a diameter of 0.1 to 2.0 mm, preferably 0.2 to 1.0 mm, and more preferentially 0.3 to 0.5 mm. The fluid discharge openings are each formed in particular as a drill hole having a constant or at least substantially constant inner diameter, preferably by means of a laser.

According to embodiments of the inventive spray pipe, same exhibits a total length of 0.5 to 1.5 m comprising 40 to 120 fluid discharge openings.

One preferential embodiment of the inventive spray pipe provides for selecting the number of fluid discharge openings and/or the distance between the at least one first fluid discharge opening and its adjacent second fluid discharge opening and/or the first and second direction such that at a nozzle pressure of between 0.5 bar to 2.5 bar, the jets of fluid exiting from the first and second fluid discharge openings are atomized as completely as possible at the point at which the direction vectors of the first and second direction intersect.

The invention relates not only to a spray pipe of the type described above but also to a wash bar for cleaning a cylinder in a printing press, wherein said wash bar comprises at least one spray pipe of the type according to the invention as described above.

With offset printing presses, it is periodically necessary to clean particularly the plate cylinder, the blanket cylinder and the impression cylinder in order to achieve good print quality. It may also be necessary to clean further ink-conducting or dampening solution-conducting cylinders by means of a wash bar or other cleaning device. During a cleaning procedure, in which the entire washing bar or a part of the washing bar is positioned on the cylinder surface of a rotating cylinder of a printing press, the printing operation of the printing press needs to be paused. The cleaning cloth, which can for example be designed as a cleaning fleece, is generally guided off a supply roll, between the cylinder to be cleaned and a pressing element, and onto a take-up roll. During the cleaning process, the cleaning cloth is pressed by the pressing element onto the cylinder surface which is moved relative to the washing bar. The cleaning cloth as well as the pressing element span the entire length of the cylinder to be cleaned. Alternatively, however, the use of traversing systems is also known.

Due to the rotational movement of the cylinder, the entire surface of the cylinder to be cleaned is swept by the cleaning cloth. Moreover, the cleaning cloth is moistened with a suitable cleaning fluid in order to achieve effective removal of contaminants, ink residues and paper dust. The inventive spray pipe is thereby used to moisten the cleaning cloth with the applicable cleaning fluid.

The following will reference the accompanying drawings in describing an exemplary embodiment of the inventive spray pipe in greater detail.

Shown are:

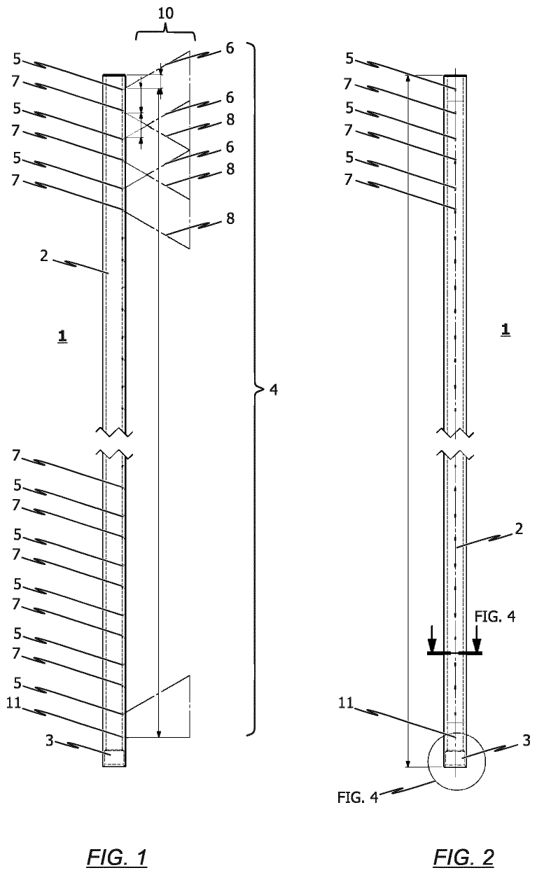

FIG. 1 a schematic and side view of an exemplary embodiment of the spray pipe according to the invention in sectional view;

FIG. 2 a plan view of the exemplary embodiment of the inventive spray pipe according to FIG. 1 in sectional view;

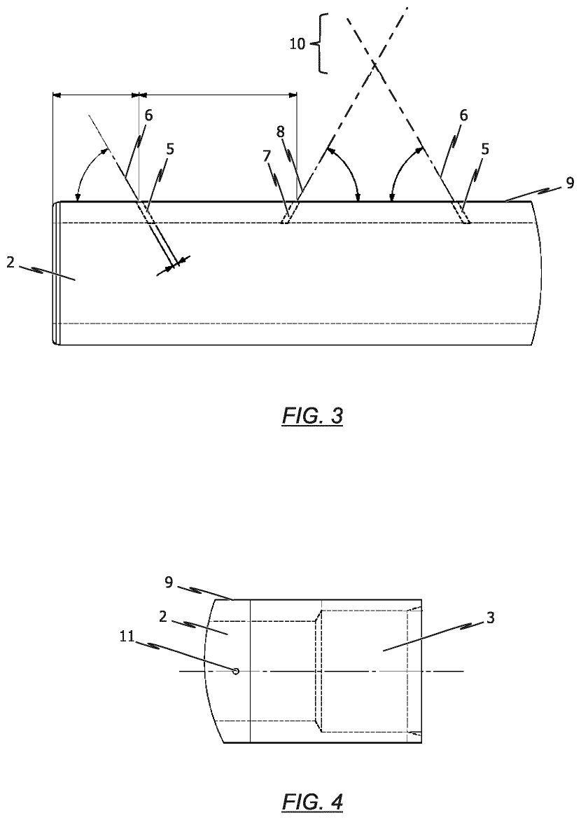

FIG. 3 an enlarged schematic view of a region of the spray pipe according to FIG. 1;

FIG. 4 an enlarged schematic view of a region of the spray pipe according to FIG. 2; and

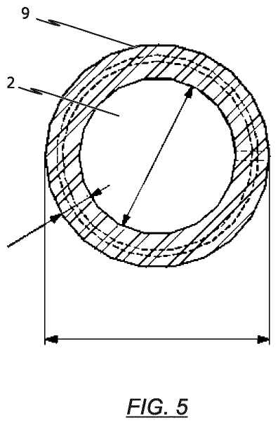

FIG. 5 a schematic sectional view of the spray pipe according to FIG. 1.

The accompanying drawings show a spray pipe 1 serving as a fluid spraying device which comprises a channel-shaped fluid chamber 2 closed on the left side, for example by means of a corresponding stopper. On the right side, the spray pipe 1 comprises a fluid inlet 3, which is shown in detail in FIG. 4.

A plurality of fluid discharge openings 5, 7 are provided on the channel-shaped fluid chamber 2 in a spraying region 4.

The fluid discharge openings 5, 7 are divided into first fluid discharge openings 5 and corresponding adjacently arranged second fluid discharge openings 7. These two types of fluid discharge openings 5, 7 differ from one another in their respective orientation. Specifically provided is for the first fluid discharge openings 5 to extend relative to a first direction and the second fluid discharge openings 7 to extend relative to a second direction, wherein the second direction differs from the first direction in such a way that the direction vectors 6, 8 of the first and second direction intersect in an atomizing region 10 distanced from the spray pipe 1.

The embodiment depicted as an example in the drawings provides for an angle spanning 30° between the first direction vector 6 and a line intersecting the first fluid discharge opening 5 and perpendicular relative to the surface area 9 of the spray pipe 1. At the same time, an angle spanned between the second direction vector 8 and a line intersecting the second fluid discharge opening 7 and perpendicular relative to the surface area 9 of the spray pipe 1 is likewise 30°, at least in the embodiment depicted in the drawings.

It can be seen in particular from the depiction in FIG. 4 that, in contrast, the last fluid discharge opening 11, which abuts fluid inlet 3, is at a 90° orientation with respect to the surface area 9 of the spray pipe so as to prevent a stream of fluid from being sprayed in an area outside of the atomizing region 10 via said fluid discharge opening 11.

In the embodiment depicted in the drawings, the distance between the fluid discharge openings 5, 7 on the surface area 9 of the spray pipe 1 amounts to approximately 11 mm. The distance is thereby selected such that at a nozzle pressure of between 0.5 bar to 2.5 bar, the jets of fluid exiting the fluid discharge openings 5, 7 are atomized as completely as possible in atomizing region 10.

The invention is not limited to the embodiment depicted in the drawings as an example but rather yields from an integrated overall consideration of all the features disclosed herein.

### LIST OF REFERENCE NUMERALS

1 spray pipe
2 channel-shaped fluid chamber
3 fluid inlet
4 spraying region
5 first fluid discharge opening
6 first direction vector
7 second fluid discharge opening
8 second direction vector
9 surface area
10 atomizing region
11 end fluid discharge opening

1. A spray pipe (1) for a printing press roller cleaning device, wherein at least parts of the spray pipe (1) extend in a longitudinal direction and include a plurality of fluid discharge openings (5, 7, 11) formed in a wall of the spray pipe (1), wherein a first fluid discharge opening (5) extends with respect to a first direction and a second fluid discharge opening (7) adjacent to the first fluid discharge opening (5) extends with respect to a second direction, wherein the second direction differs from the first direction such that direction vectors (6, 8) of the first and second directions intersect in an atomizing region (10) distanced from a surface area (9) of the spray pipe (1).

2. The spray pipe (1) according to claim 1, wherein the spray pipe (1) has a plurality of the first fluid discharge openings (5) with associated second fluid discharge openings (7), wherein the respective direction vectors of the directions, relative to which the first and second fluid discharge openings (5, 7), are aligned and lie in a common plane.

3. The spray pipe (1) according to claim 1, wherein the direction vectors (6, 8) of the first and second direction intersect in the atomizing region (10) at an intercept point, the shortest distance of which to the surface area (9) of the spray pipe (1) is at most three times an inner diameter of the spray pipe.

4. The spray pipe (1) according to claim 1, wherein the direction vectors (6, 8) of the first and second direction intersect in the atomizing region (10) at an intercept point, the shortest distance of which to the surface area (9) of the spray pipe (1) is at least one half times an inner diameter of the spray pipe.

5. The spray pipe (1) according to claim 1, wherein an angle spanned between the first direction vector (6) and a line intersecting the first fluid discharge opening (5) and perpendicular to the surface area (9) of the spray tube (1) is between 10° to 50°.

6. The spray pipe (1) according to claim 1, wherein an angle spanned between the second direction vector (8) and a line intersecting the second fluid discharge opening (7) and perpendicular to the surface area (9) of the spray tube (1) is between 10° to 50°.

7. The spray pipe (1) according to claim 1, wherein the fluid discharge openings (5, 7, 11) each have a diameter of between 0.1 mm and 2.0 mm.

8. The spray pipe (1) according to claim 1, wherein the spray pipe (1) exhibits a length of between 0.5 m and 1.5 m and between 40 and 120 fluid discharge openings (5, 7, 11).

9. The spray pipe (1) according to claim 1, wherein the fluid discharge openings (5, 7, 11) are arranged in a straight line extending in the longitudinal direction of the spray pipe (1) on the surface area (9) of said spray pipe (1).

10. The spray pipe (1) according to claim 1, wherein discharge openings (5, 7, 11) are each formed as holes having a at least a substantially constant inner diameter.

11. The spray pipe (1) according to claim 1, wherein discharge openings (5, 7, 11) are adapted and configured on the spray pipe such that at a nozzle pressure of between 0.5 bar to 2.5 bar, jets of fluid exiting from the first and second fluid discharge openings (5, 7) are completely atomized at the point at which the direction vectors (6, 8) of the first and second direction intersect.

12. The spray pipe (1) according to claim 1, wherein the spray pipe (1) exhibits a first end region and an oppositely disposed second end region, wherein at least the fluid discharge opening (11) abutting the first or second end region extends along a direction at a direction vector which is at least substantially perpendicular to the surface area (9) of the spray pipe (1).

13. The spray pipe (1) of claim 1 comprising a fluid applicator of a printing press roller cleaning device for cleaning the rotating rollers of a roller train containing a plurality of successive printing press rollers.

14. The spray pipe (1) of claim 1 comprising a wash bar wherein the spray pipe is adapted and configured to moisten a wash cloth section of a wash cloth for cleaning the surface area (9) of a cylinder to be cleaned in the printing press.

15. The spray pipe (1) of claim 1 comprising a wash brush wherein the spray pipe is adapted and configured to moisten a wash brush for cleaning the surface area (9) of a cylinder to be cleaned in the printing press. cm 16. The spray pipe (1) according to claim 5, wherein the angle spanned between the first direction vector (6) and the line intersecting the first fluid discharge opening (5) and the perpendicular to the surface area (9) of the spray tube (1) is between 25° and 35°.

17. The spray pipe (1) according to claim 6, wherein an angle spanned between the second direction vector (8) and the line intersecting the second fluid discharge opening (7) and the perpendicular to the surface area (9) of the spray tube (1) is between 25° to 35°.

18. The spray pipe (1) according to claim 7, wherein the diameters of the fluid discharge openings (5, 7, 11) are between 0.3 mm and 0.5 mm.

19. The spray pipe (1) according to claim 1, wherein a number of fluid discharge openings (5, 7, 11) and the distance between the at least one first fluid discharge opening (5) and its adjacent second fluid discharge opening (7) is selected such that at the nozzle pressure of between 0.5 bar to 2.5 bar, jets of fluid exiting from the first and second fluid discharge openings (5, 7) are completely atomized at the point at which the direction vectors (6, 8) of the first and second direction intersect.

20. The spray pipe (1) according to claim 1, wherein the number of fluid discharge openings (5, 7, 11) and the first and second direction are selected such that at the nozzle pressure of between 0.5 bar to 2.5 bar, jets of fluid exiting from the first and second fluid discharge openings (5, 7) are completely atomized at the point at which the direction vectors (6, 8) of the first and second direction intersect.
